(19) United States
(12) Patent Application Publication
(10) Pub. No.: US 2018/0085966 A1
(43) Pub. Date: Mar. 29, 2018

(54) FOOD PRODUCT SLICER WITH ASSOCIATED PORTION SCALE UNIT AND/OR USAGE AND ALERT FUNCTIONS

(71) Applicant: ILLINOIS TOOL WORKS INC., Glenview, IL (US)

(72) Inventors: Scott N. Schmidt, Neenah, WI (US); Ruben T. Huerta-Ochoa, Glenview, IL (US); Lawrence S. Leung, Troy, OH (US)

(21) Appl. No.: 15/708,242

(22) Filed: Sep. 19, 2017

Related U.S. Application Data
(60) Provisional application No. 62/475,371, filed on Mar. 23, 2017.
(60) Provisional application No. 62/399,599, filed on Sep. 26, 2016.

(51) Int. Cl. B26D 7/30; B26D 1/143; B26D 5/00; B26D 7/22; B26D 7/12; B26D 7/06; G05B 19/048; G05B 19/409

(52) U.S. Cl. CPC B26D 7/30; B26D 1/143; B26D 5/00; B26D 7/225; B26D 2007/0018; B26D 7/0616; G05B 19/048; G05B 19/409; B26D 2210/02; B26D 7/12

(57) ABSTRACT

A food slicer for slicing and weighing food items includes a slicer body and a slicer knife mounted for rotation relative to the slicer body. The slicer knife includes a peripheral cutting edge. A food product carriage is mounted to the slicer body for reciprocating movement back and forth past a cutting zone of the slicer knife. A portion scale is mounted on the slicer body and includes a weigh platter on a slice exit side of the slicer knife. A controller of the food slicer is configured for automated operations and/or monitoring and alerting based upon slicer conditions.

### CROSS-REFERENCES

This application claims the benefit of U.S. Application Nos. 62/399,599, filed Sep. 26, 2016 and 62/475,371, filed Mar. 23, 2017, both of which are incorporated herein by reference.

### TECHNICAL FIELD

This application relates generally to food product slicers used for slicing bulk food products and, more specifically, to a food product slicer including a usage accumulation feature and/or a portion scale unit.

### BACKGROUND

Typical reciprocating food slicers have a rotatable, circular or disc-like slicing blade, an adjustable gauge plate for determining the thickness of the slice and a carriage for supporting the food as it is moved back and forth past the cutting edge of the knife during slicing. A drive motor is typically linked to drive the carriage back and forth during an automatic slicing operation carried out by a controller of the slicer. The gauge plate is situated along the edge of the knife toward the front of a slicing stroke and is laterally movable with respect to the knife for determining the thickness of the slices to be cut. These slicers are commonly used in restaurant and grocery businesses, among others.

The use of slicer mounted knife sharpening assemblies to sharpen the peripheral edge of the slicer knife when necessary is also known. U.S. Pat. No. 8,220,383 discloses a sharpener with a timed sharpening operation where a slicer operating parameter (e.g., slicing strokes) can be monitored and a sharpen knife annunciator (e.g., a light element) triggered when the operating parameter reaches a certain level (e.g., set threshold number of slicing strokes). However, the slicing stroke or other operating parameter data is generally not available to users, service persons or others.

Another feature of slicer usage is represented by product weight sliced. To date, attempts to weigh product as it is sliced have not proven successful.

It would be desirable to provide (i) a food product slicer that incorporates a slicer usage feature that automatically tracks slicer usage data and makes such data available to slicer users and owners, service and maintenance personnel and/or the slicer manufacturer and/or (ii) a portion scale as part of or in combination with a food product slicer.

### SUMMARY

In one aspect, a food product slicer includes a slicer body, a slicer knife mounted for rotation relative to the slicer body, a food product carriage mounted to the slicer body for reciprocating movement back and forth past a cutting zone of the slicer knife and a slicer controller with a slicer usage accumulator function to accumulate and display slicer usage data.

In another aspect, a food slicer for slicing and weighing food items includes a slicer body, a slicer knife mounted for rotation relative to the slicer body, the slicer knife having a peripheral cutting edge, a food product carriage mounted to the slicer body for reciprocating movement back and forth past a cutting zone of the slicer knife, and a portion scale mounted on the slicer body and including a weigh platter on a slice exit side of the slicer knife.

In another aspect, a food slicer for slicing food items includes a slicer body, a slicer knife mounted for rotation relative to the slicer body, the slicer knife having a peripheral cutting edge, and an associated knife drive motor. A slicer knife sensor system is positioned proximate a peripheral edge of the slice knife for determining a distance between at least one sensor and the slice knife. A controller is configured to monitor output from the slicer knife sensor system and to identify a wobble condition of the slicer knife based upon variations in the determined distance during slicer knife rotation.

In a further aspect, a food slicer for slicing food items includes a slicer body, a slicer knife mounted for rotation relative to the slicer body, the slicer knife having a peripheral cutting edge, and an associated knife drive motor. The slicer includes a display device. A carriage drive motor is linked for automatic reciprocation of the food product carriage. A system of sensors includes: at least one temperature sensor, at least one vibration/shock sensor and at least one motor load sensor. A controller configured to monitor the system of sensors to identify one or more fault conditions in the nature of actual fault conditions or potential fault conditions, and upon identification a fault condition the controller (i) logs the fault condition in memory and (ii) displays an alert message on the display device and/or sends an alert message via a communications link to another device.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a side elevation of a food product slicer;

FIG. 2 is a block diagram of an exemplary slicer control system;

FIG. 3 shows a perspective of a slicer;

FIG. 4 shows a perspective of a portion scale;

FIGS. 5-6 show perspectives of the portion scale mounted to the slicer;

FIG. 7 shows another embodiment of a portion scale mounted on a slicer body;

FIG. 8 shows a partial perspective of interconnection of a portion scale to a slicer body;

FIGS. 9-11 show other perspectives of the portion scale;

FIGS. 12 and 13 show an exemplary catch platter assembly of the portion scale;

FIG. 14 shows an exemplary control system;'

FIG. 15 shows an exemplary knife monitoring system;

FIG. 16 shows a top plan schematic view of an exemplary food department within a store; and

FIG. 17 shows an exemplary wireless communications arrangement.

### DETAILED DESCRIPTION

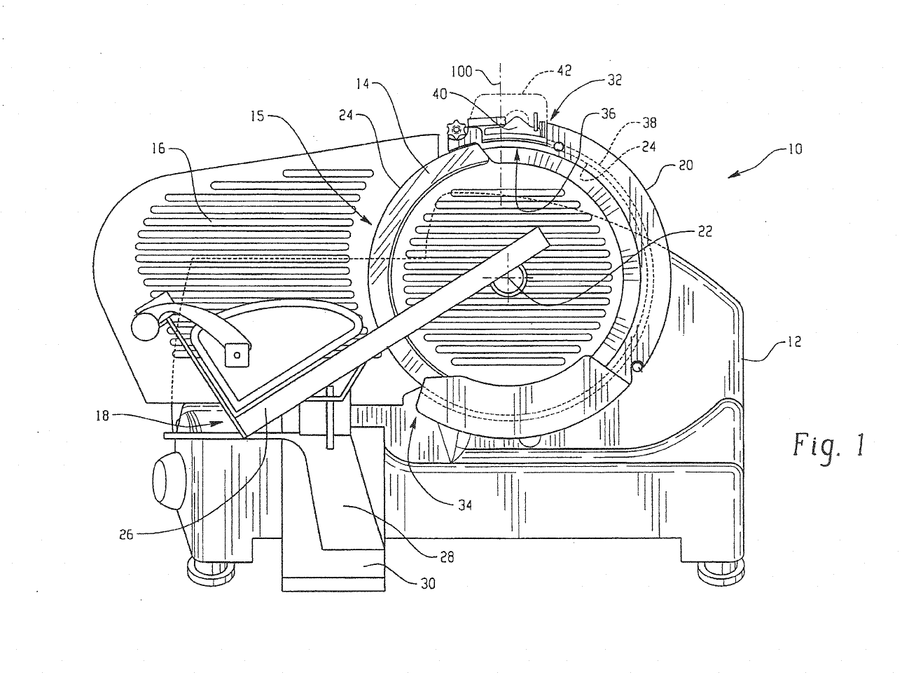

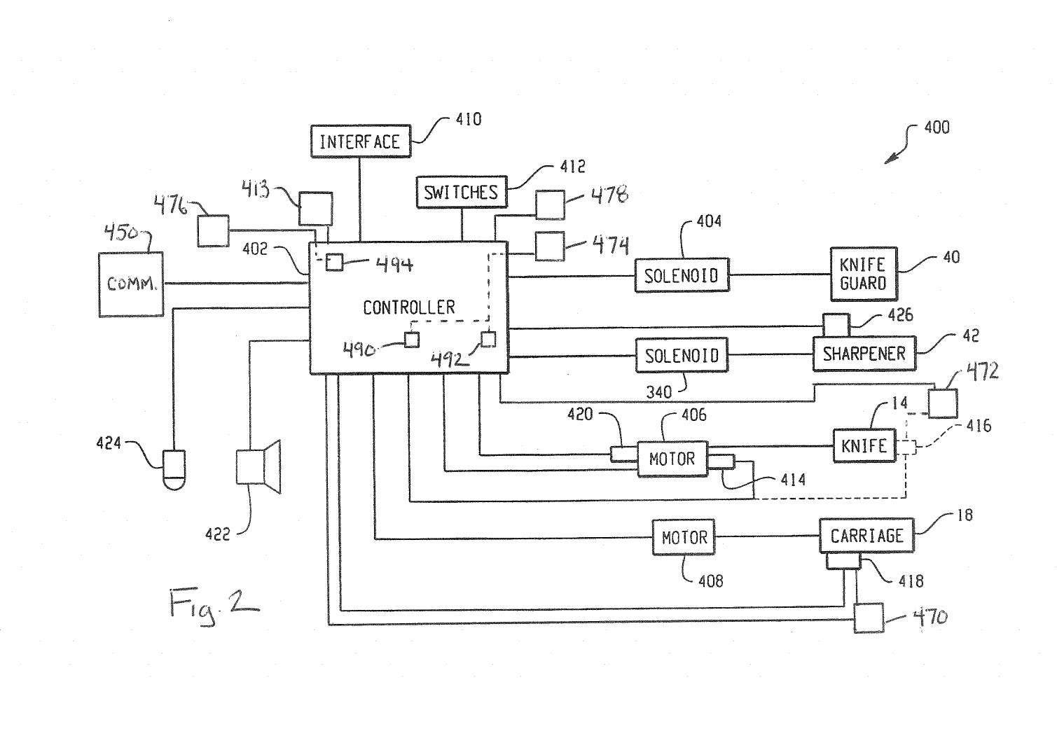

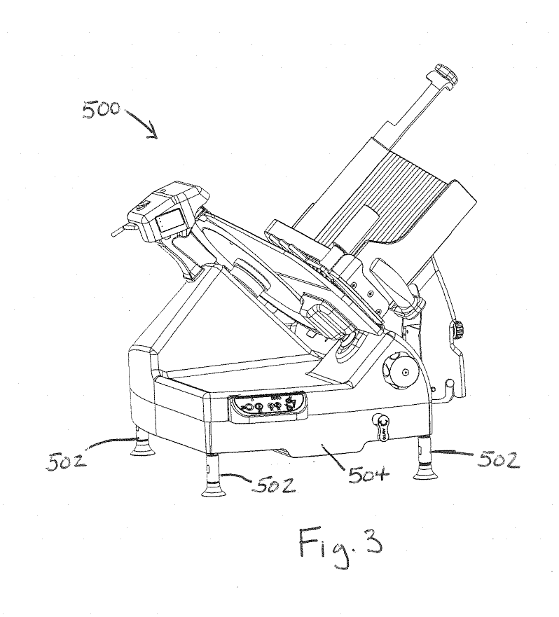

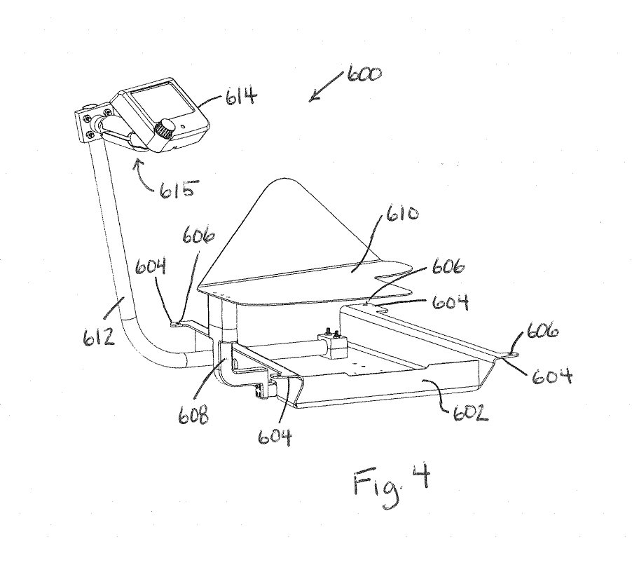

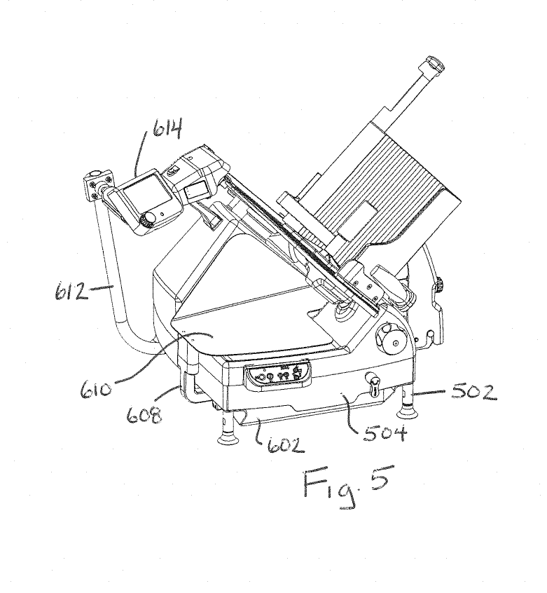

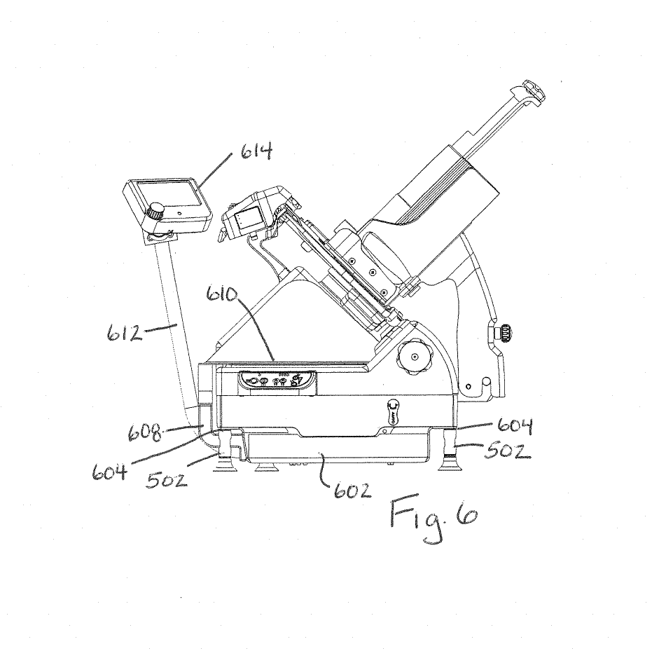

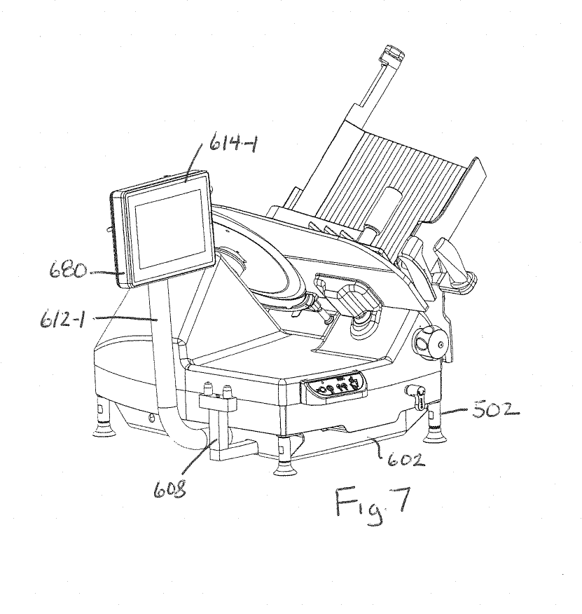

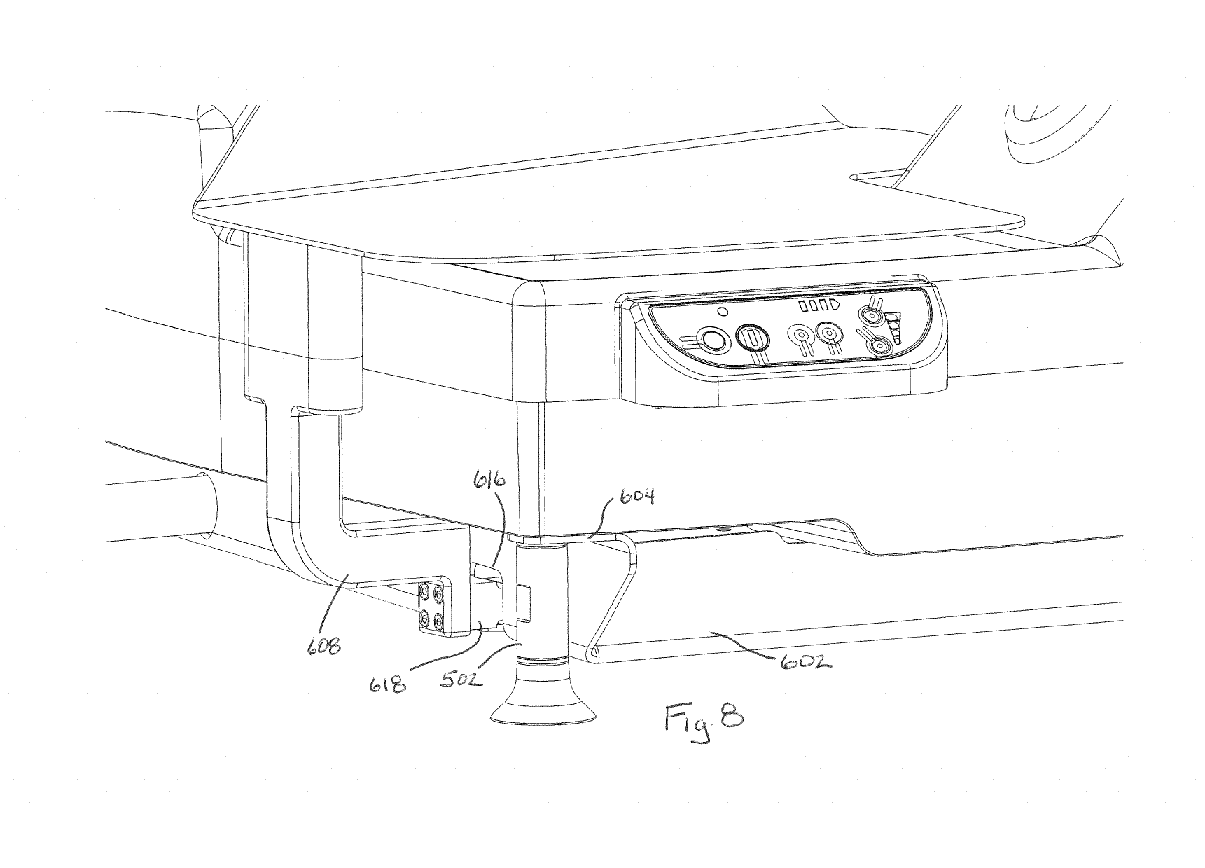

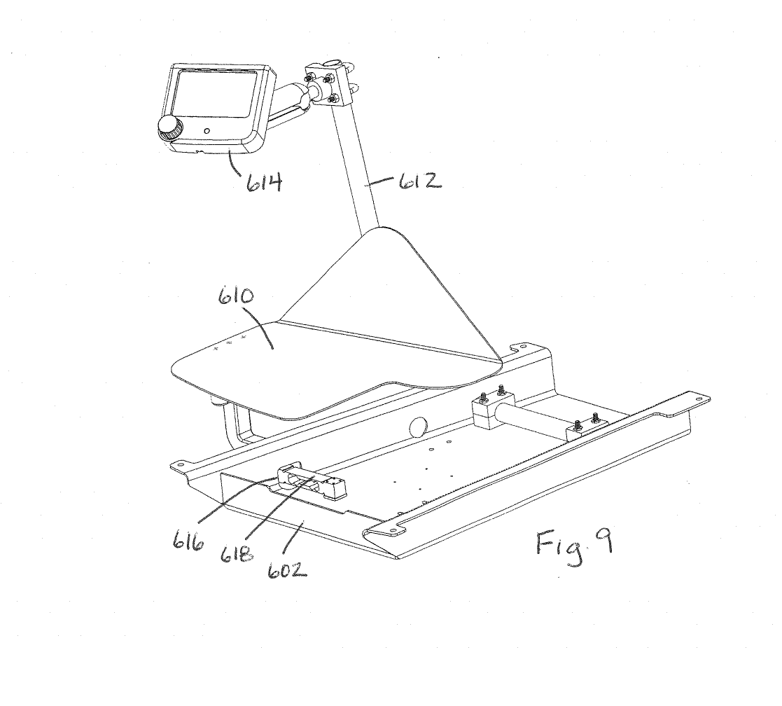

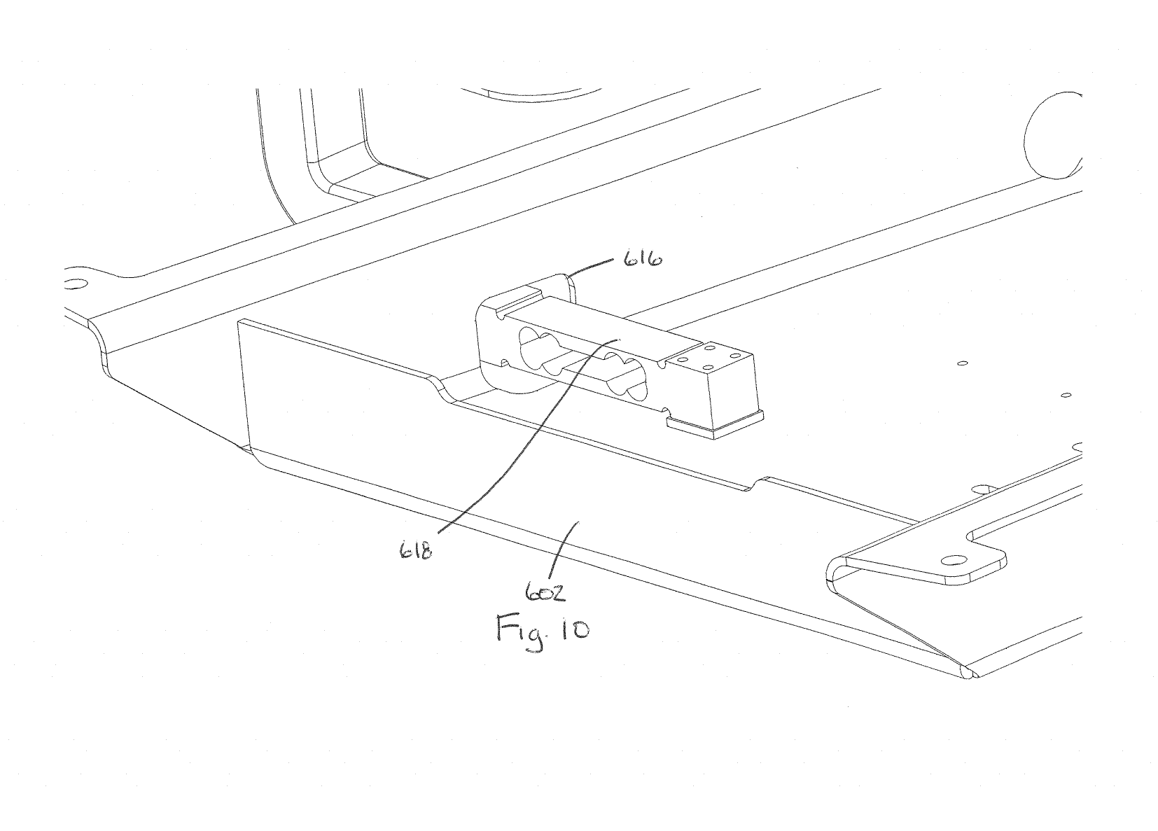

Referring to FIG. 1, a food slicing machine 10 includes housing 12 that, with other components such as an internal casting form part of the slicer body (often times also referred to as a base). Slicing machine 10 also includes a circular slicing knife 14, gauge plate 16, product supporting carriage 18 and a cover plate 20. The circular slicing knife 14 is mounted to the slicer body for rotation about an axis 22 by a motor or other drive (not shown). A peripheral cutting edge 24 of the knife is exposed in a cutting region 15 of the knife that is proximate the gauge plate 16 (e.g., generally extending from approximately a seven o'clock position to an eleven o'clock position in the illustrated embodiment, with other variations possible). The gauge plate is movable transversely with respect to a plane defined by the peripheral edge 24 of the knife to control slice thickness, and can be located in a “zero” position wherein it is slightly raised above the cutting zone of the peripheral edge 24. The food product carriage 18 includes a tray 26 mounted on support arm 28, which in turn may be pivotally mounted to a transport 30 that extends into the housing. The transport 30 is supported internal of the housing for linear, reciprocating movement back and forth past the slicer knife 14 in any suitable manner, variations of which are known in the art. Carriage movement may be implemented manually and/or automatically (e.g., as by a drive motor and belt system, by hydraulics or by other means). As food product is moved past the cutting edge of the knife in a slicing stroke, the food product on the tray 26 slides across the outwardly facing surface of the cover plate 20, which surface may be formed with raised ridges to improve slidability.

The illustrated cover plate 20 covers the peripheral cutting edge 24 of the slicer knife 14 from about a one o'clock position 32 to about a seven o'clock position 34. The peripheral cutting edge 24 is shown in shadow beneath the cover plate 20. In a twelve o'clock region 36 of the slicer knife 14, the cover plate diameter decreases to provide a space or opening at which the edge of knife can be sharpened. The cover plate 20 also extends over a ring guard 38 (only inner edge shown in shadow in FIG. 1) that is disposed about the peripheral cutting edge along at least a portion of the non-cutting zone of the circular slice knife, leaving a gap between ring guard and the peripheral cutting edge as shown. The ring guard may be fixed to the housing 12 in a stationary manner, or may be fixed to the housing to permit some movement for cleaning as described in U.S. Pat. No. 5,509,337. In either case, the ring guard is positioned to protect the cutting edge 24 of the slicing knife 14. In the illustrated embodiment, the ring guard 38 does not extend into the twelve o'clock zone 36 of the slicer knife, but such zone is provided with a knife guard member 40 that moves to permit sharpening by a sharpener assembly 42 (shown only in outline in FIG. 1). For example, knife guard member 40 may pivot about an axis 100 during sharpening. A small gap is provided between the knife guard member 40 and the peripheral edge 24 of the knife as shown.

The configuration of the sharpening assembly 42 provided in connection with a given slicer can vary widely. For example, a sharpener assembly similar to those described in U.S. Pat. No. 8,220,383 may be used.

Referring to FIG. 2, an exemplary slicer control system diagram 400 is shown. A controller 402 (which may include a processor and memory, such as flash memory, or other control arrangement) is connected with a solenoid 404 that may be provided for moving the knife guard member 40. The term controller is also intended to broadly encompass any circuit (e.g., solid state, application specific integrated circuit (ASIC), an electronic circuit, a combinational logic circuit, a field programmable gate array (FPGA)), processor (e.g., shared, dedicated, or group—including hardware or software that executes code) or other component, or a combination of some or all of the above, that carries out the control functions of the machine or the control functions of any component thereof. Solenoid 404 could be eliminated where the knife guard member 40 is manually movable. Controller 402 may also be connected with a solenoid 340 associated with the sharpener assembly 42. Where the sharpener assembly 42 is manual, solenoid 340 may be eliminated.

Controller 402 is connected with a knife drive in the form of motor 406, and is also connected with a carriage drive in the form of motor 408. The carriage 18 may be selectively uncoupled from motor 408 to also permit manual movement of the carriage. Controller 402 may also connected with a user interface display 410 and with a user input in the form of one or more input keys or switches 412. A separate ON/OFF switch 413 may also be provided. If the display 410 is of the touch sensitive type, the display may function as a user input in addition to or in place of user input 412. A motor encoder 414 provides feedback to the controller 402, from which the controller can determine knife rotations if needed. Alternatively, an encoder or other sensor 416 may be associated with the knife 14 itself to track knife rotation. A sensor 418 provides feedback to the controller 402 regarding carriage position and/or movement. Sensor 418 may be as simple as an end of stroke switch or may take the form a more complex encoder arrangement. Different types of sensors, mechanical, optical or magnetic may also be sued. A motor load sensor 420 may also be provided for the knife motor 406 and/or a similar load sensor 421 for the carriage drive motor 408. Audible and visual annunciators 422 and 424 are also shown, along with a communications interface 450 and a knife sharpen sensor 426.

Referring to FIG. 3, an exemplary food slicer 500 is shown. The food slicer includes a set of support legs 502 detachable from the underside of the body 504 of the slicer (e.g., by threading). FIG. 4 shows an exemplary portion scale 600 adapted for use with the food slicer 500. The portion scale 600 includes a base 602 with a set of mount flanges 604, each mount flange having an opening 606. The mount flanges 604 and openings 606 are positioned for alignment with the support legs 502 of the food slicer 500, so that the portion scale can be attached to the body of the slicer using the support legs (e.g., using the threaded portion of each leg 502). Thus, part of each slicer support leg passes through the flange opening 606, which provides for relatively simple assembly of the portion scale onto the slicer body. The base 602 may, for example, be of cut and bent sheet metal (e.g., stainless or other coated metal) construction in the form of a tray with a bottom wall and upturned side walls. A support arm 608 extends from a mount within the base 602 and holds a food product catch platter 610 in position on the slice exit side of the knife where sliced food product will fall onto the platter. A support arm 612 extends from another mount within the base and holds a scale user interface 614. The user interface may be mounted to the arm 608 with a suitable mount assembly 615 to enable a swivel and rotate functionality. The user interface may be in the form of a display with an associated encoder dial with integrated pushbutton switch. In another embodiment, shown in FIG. 7, the user interface 614-1, in the form of a touch screen display, is mounted atop the support arm 612-1, so that the housing 680 of the user interface 614-1 covers the opening in the top of the support arm 612-1 (which is used to run wiring as will be further described below. This configuration helps to inhibit food debris or other contaminants from entering the top of the support arm 612-1.

FIGS. 5 and 6 show perspective and front elevation views of the portion scale 600 connected with the slicer 500 for combined operation. The catch platter 610 sits in position such that food product slices drop onto the platter for weighing.

FIG. 8 shows an enlarged partial perspective of the interconnection of the portion scale and the slicer via the flange 604 and support foot 502. A side slot 616 in the base 602 is provided, through which one end of a load cell 618 extends, with the support arm 608 connected to the load cell 618 as shown. As seen in FIGS. 9 and 10, the other end of the load cell 618 is mounted to the bottom wall of the base 602, with the load cell cantilevered from the connection to provide the load cell functionality.

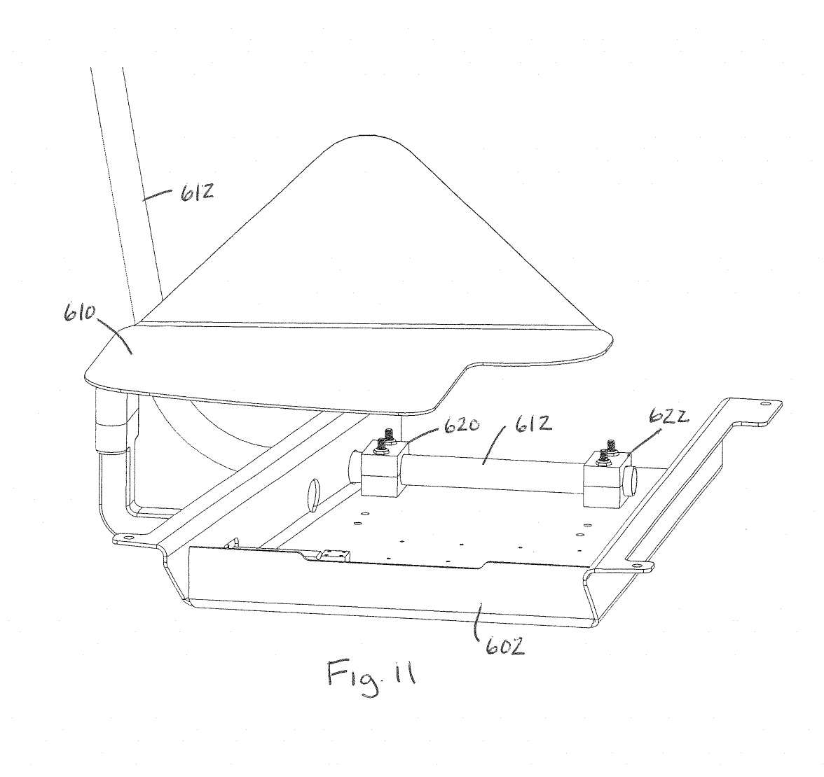

FIG. 11 shows the lower end of the arm 612 extending within the base and including mounts 620, 622 for stability. Here, each mount is formed by a pair of opposed bracket blocks that together form a tubular shape that conforms to the tubular shape of the mount arm 612, with the bracket blocks clamped together by a set of fastener assemblies.

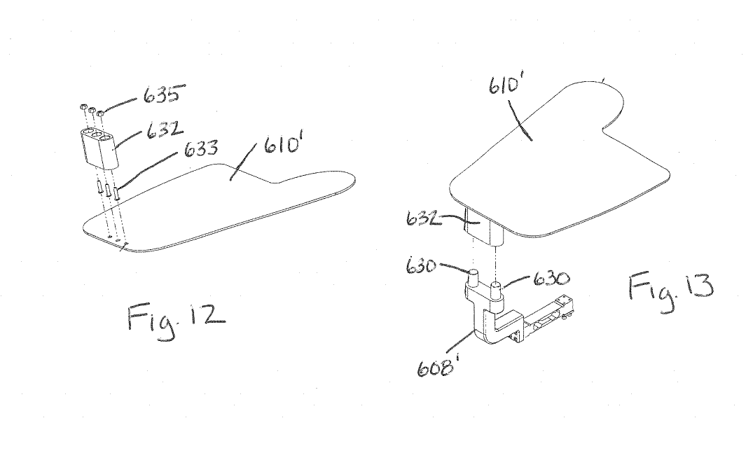

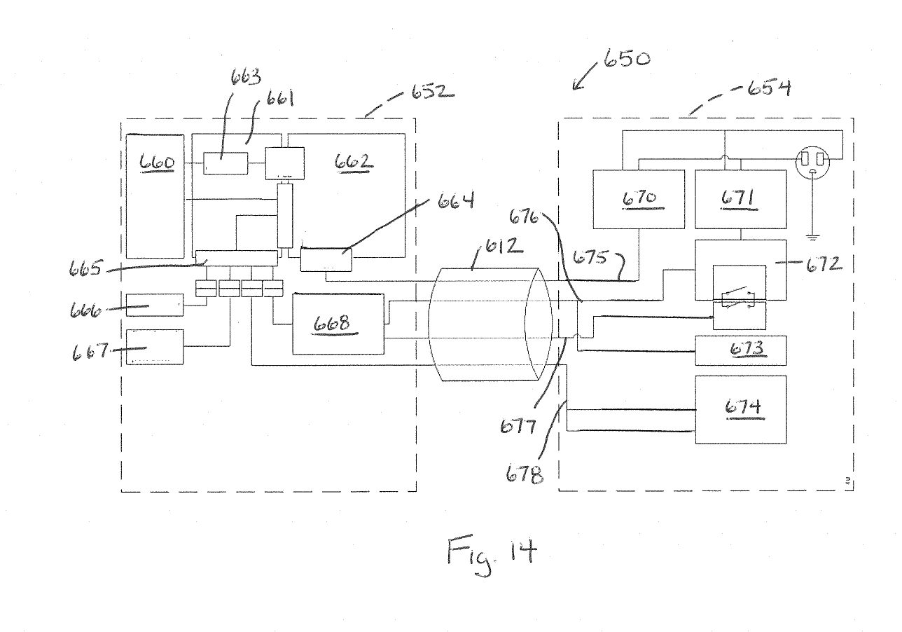

FIGS. 12 and 13 show an exemplary assembly configuration for removable mounting of a catch platter 610′ (here shown with a slightly different form than catch platter 610) to a support arm 608′ via a set of pins 630 that fit within bottom openings of a mount block 632. A set of threaded mount studs 633 may be welded or otherwise connected to the bottom of the platter 610′ in order to secure the mount block 632 to the platter by bolts 635 within through openings of the mount block 632. This arrangement facilitates relatively simple removal of the platter for cleaning (e.g., by simply lifting the platter upward so that the mount block 632 clears the pins 630).

The portion scale 600 can be incorporated into new slicers 500, or can be retrofit to existing slicers in the field. The portion scale does not increase the overall footprint of the slicer 500, and is fully removable, in one piece, for cleaning.

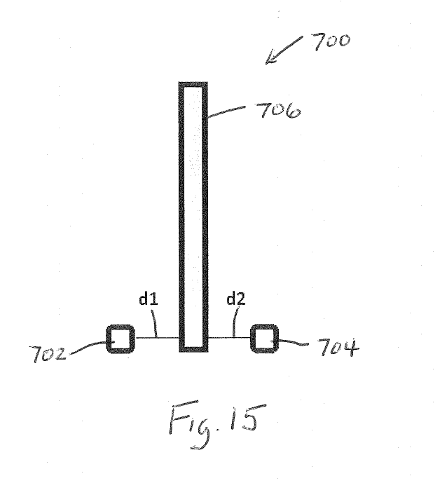

FIG. 14 shows an exemplary control system 650 of the slicer, including a portion 652 within the user interface housing and a portion 654 within the base tray 602, with wiring passing through the tubular support arm 612 to interconnect the two portions. Here, portion 652 includes LC display 660, LCD printed circuit board 661 with display converter 663 and breakout header 665, a scale controller 662 with USB power port 664, a tri-color LED set 666, an encoder with integrated pushbutton 667 and slicer user interface communications printed circuit board 668. The portion 654 includes AC/DC converters 670, 671, with converter 670 providing power to the user interface. Portion 654 also includes the scale 672 (which includes the load cell, an A/D converter and may include a processor), keyboard printed circuit board 673 and slicer control board 674. Interconnecting line 675 provides power, line 676 represents a serial communications path (e.g., RS232, RS486, CAN), line 677 represents a scale power control (triggered by the interface) and line 678 provides slicer operation data such as knife running, carriage running, etc.

A control system (or controller) 650 such as that illustrated may be configured to provide a variety of useful features. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the machine or the control functions of any component thereof. Various components/features of above-described system 400 and controller 402 may be included in the control system/controller 650 shown in FIG. 14. Here, the controller 650 is configured as a distributed controller, with components in various locations (e.g., some below or within the slicer body and some within the user interface). By employing the additional processing power provided in the user interface, a combination scale/slicer can carry out functions not previously embodied in food product slicers.

In this regard, the controller 650 is capable of tracking and responding to various slicer data. In one technique, the controller 650 tracks one or more of (i) a count of slicing strokes of the food product carriage 18, based upon the feedback from sensor 418 (FIG. 2), (ii) slicer knife run time and slicer carriage run time (e.g., as indicated by on time of the knife motor 406 or by on time of the carriage motor 408, each of which may be tracked in controller run time counters 490 or 492), (iii) slicer on/off iterations (e.g., as reflected by an internal counter 494), (iv) slicer power usage (e.g., as indicated by load sensors 420 and/or 421 alone or in combination with run time data), and/or (v) a total sliced weight (e.g., as tracked over time by a weighing device on the slicer in combination with an on-board weight adder/counter).

The controller 650 may be configured to (a) continuously display any or all of the slicer usage accumulation data (e.g., on the display screen of interface 410 or on individual respective displays 470 (e.g., for slicing stroke count), 472 (e.g., for slicer run time), 474 (e.g., for slicer power use), 476 (e.g., for slicer on/off iterations) or 478 (e.g., for accumulated total sliced weight), which may be electronic or mechanical, or (b) selectively display any or all of the slicer usage accumulation data (e.g., based upon an input received from an operator/user through interface 410 or 412). A communications interface may also be provided to enable computerized access to and download of the slicer accumulation data and/or automated transmission of the data or alerts to external systems.

Following are a number of specific examples of how the control system may be configured to operate to provide advantageous functionality in the combined scale/slicer.

### Food Slicing Efficiency

The controller 650 may be configured to facilitate tracking of food slice efficiencies. In one implementation the controller 650 may include an efficiency mode (always on or triggerable through the scale user interface) for this purpose. In one implementation, when the efficiency mode is active, prior to slicing an operator activates a slice/ready to slice input (e.g., displayed on the user interface 614) and the controller responsively display a message instructing the operator to place the bulk food item to be sliced (e.g., meet chub or cheese block) on the scale platter 610. The operator may also be prompted to enter the product look-up (PLU) number of the food item. The operator then places the bulk food item on the platter 610 and the stable weight of the food item prior to slicing is captured and stored in memory. The operator then places the bulk food item on the food carriage of the slicer and begins slicing. As the slices drop onto the platter 610 the controller maintains a running total weight of the sliced food item. When the operator has sliced the desired amount (e.g., ¾ pound as requested by a customer) the operator indicates that slicing is complete (e.g., by a user input trigger or by removing the sliced food item from the platter 610) which causes the controller to capture and store the final weight of the sliced food item. The operator is then prompted via the user interface 614 to reweight the bulk food item, and the controller captures and stores the new weight of the bulk food item after slicing. The three captured weight values (i.e., initial bulk item weight (IBIW, final sliced item weight (FSIW) and final bulk item weight (FBIW)) are then used by the controller to determine efficiency for the slice operation, such as by the following equation:

Slice Eff %=FSIW/(IBIW FBIW)

The slice efficiency is then stored in a log file of the controller and may be displayed on the user interface 614 and sent to a remote system (e.g., store computer) as well. The log file may include slicer operator identity in the case of machines where an operator must login to the scale/slicer before slicing. Where the slice efficiency falls below a certain desired threshold (e.g., below a certain %) the controller may also trigger an alert to be displayed on the screen indicating that something may be wrong (e.g., a prompt to sharpen the slicer knife), and the alert could be sent to a remote system or device (e.g., store computer, manager cell phone, etc.).

In another efficiency mode, the scale/slicer controller may be configured to target slice weight to a desired target. This mode may be particularly useful in commercial operations where the sliced food product will be used to build another food item (e.g., where a certain number of slices will be used to build a sandwich item). In such operations, a specific number of slices (e.g., ten slices) may be used to build each food item and the intent is to provide consistent food item size and weight (e.g., assuring that the sandwich item is not too large or too small). Thus, in this efficiency mode, the scale/slicer controller may store a predetermined target average weight for each slice. During an operator slicing operation the scale/slicer controller tracks the weight of the food item as it is sliced, along with the number of slices (e.g., as indicated by the carriage stroke sensor). If the average weight of the slices is not within a certain range of the target average weight (e.g., within five percent on either side of the target average weight), the controller responsively prompts the operator to make an adjustment (e.g., increase slice thickness of the average weight is below the range, decrease slice thickness if the average weight is above the range, or a knife sharpen prompt). If the operator does not take corrective action in a timely manner (e.g., within a certain number of further slices or within a set time period), the scale/slicer controller may halt the slicing operation until the corrective action is taken.

### Cutting to Target Weight

The scale/slicer controller may be configured with an automatic slice to target weight mode that enables an operator to define an initiate a slice operation and then move on to another task elsewhere. For example, an operator may select the slice to target weight mode via the display device/user interface. The scale/slicer controller then prompts the operator to enter a target weight (e.g., by a manual or electronic keypad or by selecting from among a set of standard weight options that are displayed). Once the target weight is selected and the bulk food item properly loaded on the food product carriage, the operator triggers start of the slicing operation (e.g., via a manual or displayed start button) and the scale/slicer controller carries out the slicing operation automatically while monitoring a running weight of the sliced food item. When the running weight reaches the target weight, the scale/slicer controller stops the slicing operation. Upon completion the scale/slicer controller may also issue a visual or audible alert to indicate completion, and may display the total weight and slice count.

### Slicer Faults or Maintenance Problems—Temperature Based

The controller may be configured to collect, store and analyze data from various sensors on the machine.

For example, the slicer control board may include a heat sink with an associated temperature sensor, and each of the carriage motor and the knife motor may include a respective temperature sensor. The indications from these temperature sensors can be captured by the scale/slicer controller tracked over time. Where any one of the temperature sensors exceeds a set high threshold, an alert can be displayed on the user interface, an alert sent to a remote system (e.g., store computer or service personnel computer or device) and/or the machine shut down to avoid undesired machine damage or failure. The scale/slicer controller may also be configured to identify negative trends in the temperature sensor data (e.g., where the output of a temperature sensor is gradually approaching the set threshold but has not yet reached the set threshold). In such cases, alerts may be initiated (displayed and/or sent) for corrective action to be taken before a problem or failure occurs. Any of the various alerts can be logged in the scale/slicer controller and may include additional data that suggests the nature of the potential problem. Thus, the scale/slicer controller may include algorithms to analyze the data and predict or suggest what the potential problem may be.

For example, if the knife motor temperature sensor is higher than a set threshold or trending excessively then the scale/slicer controller may, as part of an alert, identify that bearings and/or lubrication for the knife drive need to be checked.

For example, where a motor temperature sensor indicates motor operation (e.g., a typical temperature for motor operation) and the heat sink temperature is lower than expected (e.g., lower than a threshold temperature expected during operation), the scale/slicer controller may, as part of an alert, identify the potential problem as debonding of the heat sink, which could result in significant damage to the electronics.

As another example, where the carriage motor temperature sensor is excessive or trending excessive, the scale/slicer controller algorithm may issue an alert suggesting that the bearings be checked, the lubrication be checked and/or that the carriage path be checked for potential obstruction.

### Slicer Faults or Maintenance Problems—Power Based

The scale/slicer controller may monitor motor current and voltage (e.g., for both drive motors). In cases where the power consumption exceeds a set threshold or is trending toward exceeding a set threshold, the scale/slicer controller algorithm may issue an alert suggesting that the bearings be checked, the lubrication be checked and/or that the carriage path be checked for potential obstruction.

### Slicer Faults or Maintenance Problems—Vibration/Shock Based

The scale/slicer control may monitor and track inputs from one or more vibration and shock sensors, such accelerometers or piezoelectric sensors to identify specific potential issues. For example, where an excessive shock condition is occurring near the end of carriage stroke, the scale/slicer controller may generate an alert indicating that the home position sensor needs to be checked. Where vibration conditions are identified that are both out of bounds (excessive) and at harmonics of the knife motor speed (knife motor shaft rotation speed) the scale/slicer controller may generate an alert indicating that the knife motor shaft bearings need to be checked. Where vibration conditions are identified that are both out of bounds (excessive) and at harmonics of the carriage motor speed (carriage motor shaft rotation speed) the scale/slicer controller may generate an alert indicating that the carriage motor shaft bearings need to be checked. Where vibration conditions are determined by the scale/slicer controller to be excessive for an reason the scale/slicer controller may generate an alert indicating that the weighing function will be adversely impacted.

### Knife Wobble or End of Life

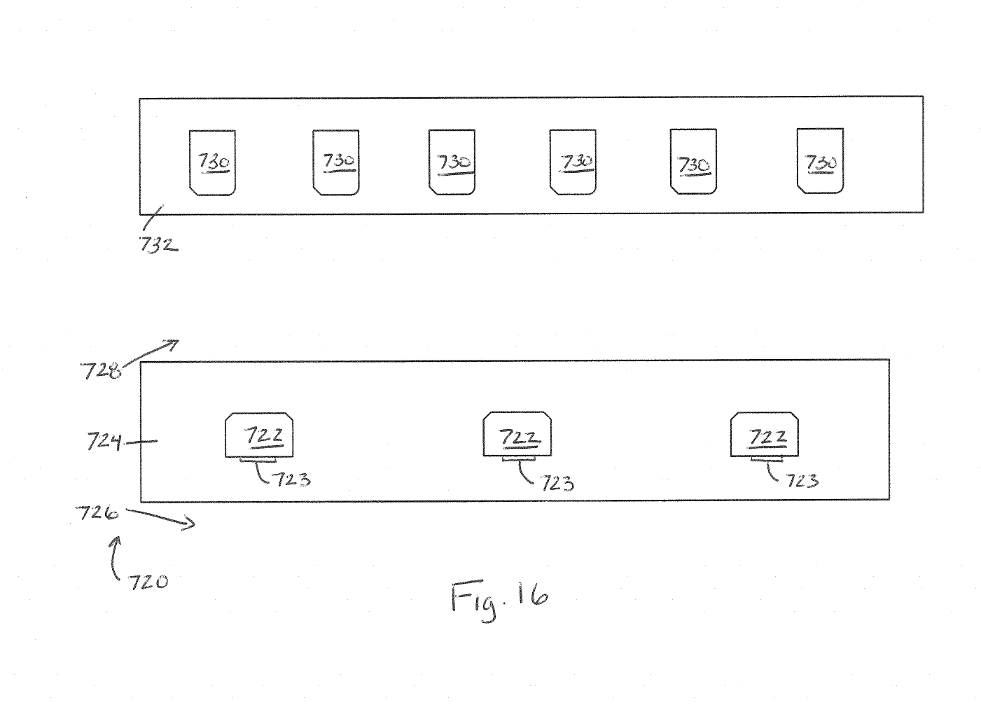

The scale/slicer may be configured with a knife monitoring system 700 such as that depicted schematically in FIG. 15. Here, the a pair of sensors 702, 704 are disposed on opposite sides of the knife 706 near the periphery of the knife. By way of example, each sensor 702, 704 may be a highly accurate and precise laser distance sensor capably of measuring distance (d1, d2) to the knife. Where the measured distance to knife varies during knife rotation (e.g., beyond a threshold distance or outside of a threshold distance range) the scale/slicer controller may identify that knife wobble is occurring and issue an alert that maintenance action needs to be taken (e.g., sharpen the knife or check knife mount). Where the distance(s) d1 and d2 are beyond a set threshold suitable for knife sharpening, the scale/slicer controller may identify that knife wobble is occurring and issue an alert that maintenance action needs to be taken in the nature of knife replacement.

### Operating History

The scale/slicer controller may be configured to track operating time and operating conditions for the purpose of routine maintenance operations. For example, the controller may maintain a running log of operating time (e.g., run time in minutes or hours) for each the slicer knife motor and the carriage knife motor, as well historical load on each motor (e.g., as detected and reported by voltage and current sensors associated with the motor drive electronics). The scale/slicer controller may include algorithms to assess the historical operation (run time and load conditions) to determine when to issue a standard maintenance notice/alert (e.g., such as lubrication notice, sharpening notice, cleaning notice, calibration notice, wear item replacement notice, etc.). The usage metrics may also be generally accessible or automatically reported to a remote device/system for other desired purposes.

As suggested above, the scale/slicer controller may cause any of the alert conditions to be displayed on-board, logged and/or sent via communications link to another system or device. The log maintained in memory of the scale/slicer controller may include the alert date, time, type of alert (e.g., an alert code) and predefined suggested instruction or action for maintenance personnel and/or an operator to check or take.

### Scale Communications

Referring to FIG. 16, an exemplary food department 720 (e.g., deli department) in a grocery or supermarket is shown and includes one or more weighing and pricing scales 722 located on or above a counter 724 (as may be formed atop a refrigerated food product display unit) in the deli department having a customer side 726 and a service person side 728. A number of combination scale/slicers 730 may be located atop another counter 732 located at the service person side 728 of the counter 724. Communications (e.g., wired or wireless) may be provided between the controllers in scale/slicers 730 and the scales 722. In this system the scale/slicers 730 can have full access to the food product data/database information utilized by the scales 722, enabling the scale/slicers 730 to obtain information about each bulk item being sliced (e.g., by having the operator input a PLU before slicing, or by using a scanner device (such as a bar code reader) incorporated into the scale/slicer, which PLU is transmitted to a scale 722, and the scale transmitting back to the scale/slicer item name, price etc.). The controller of each scale/slicer can also be configured to send information/data to the scales 722 for the purpose of the customer transaction.

In this regard, in some embodiments each combination scale/slicer 730 may satisfy legal for trade requirements/specifications, meaning that the sliced food product does not need to be reweighed by a scale 722 for the purpose of pricing the item. In such situations the scale/slicer controller may send the final sliced item weight, PLU data and other data (e.g., potentially price in situations where the scale/slicer controller is configured to calculate the price) to one of the scales 722 and the scale may automatically print the pricing label for the sliced item while displaying the weight and price on the customer facing display 723 of the scale for customer viewing, which can increase throughput and productivity in the department. Moreover, in such cases one or more of the scales 722 may be replaced by simplified label printers to which the final sliced item weight and PLU data is sent, potentially reducing overall hardware costs required for a given store food department.

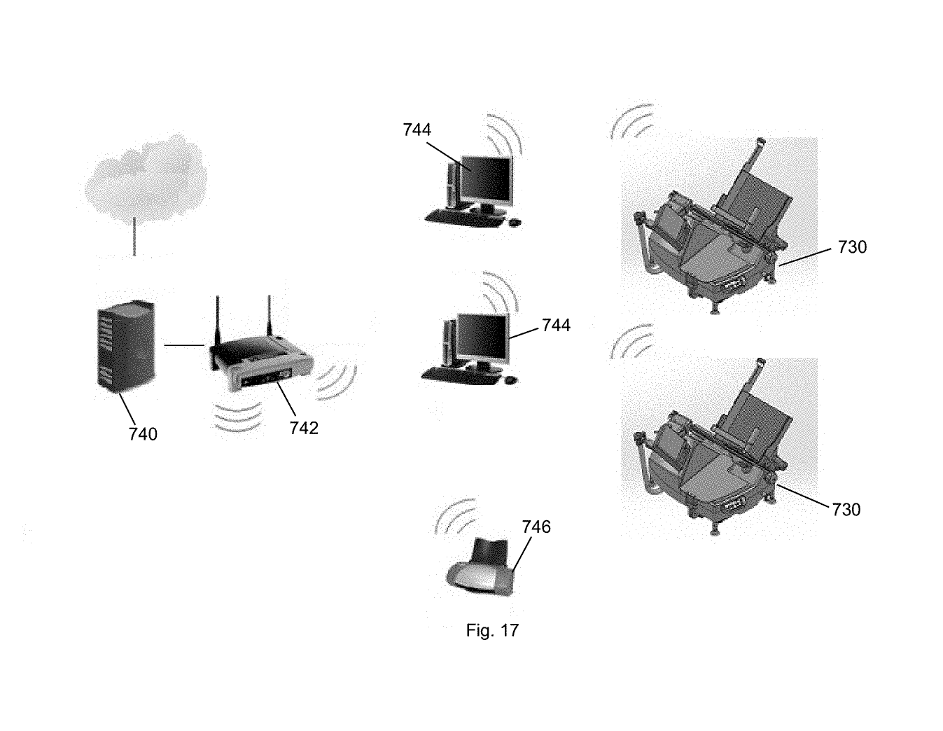

FIG. 17 shows an exemplary wireless communications system that may enable the combination scale/slicers 730 to communicate and report in accordance with the various descriptions above. The system includes a server 740, wireless router 742, point-of-sale devices 744 and a printer 746, and may include other devices, such as scales 722.

It is to be clearly understood that the above description is intended by way of illustration and example only, is not intended to be taken by way of limitation, and that other changes and modifications are possible. For example, various of the slicer monitoring and tracking functions can be implemented in slicers that do not include a portion scale.

What is claimed is:

1. A food slicer for slicing and weighing food items, comprising:
a slicer body;
a slicer knife mounted for rotation relative to the slicer body, the slicer knife having a peripheral cutting edge;
a food product carriage mounted to the slicer body for reciprocating movement back and forth past a cutting zone of the slicer knife;
a portion scale mounted on the slicer body and including a weigh platter on a slice exit side of the slicer knife.

2. The food slicer of claim 1 wherein the portion scale includes a load cell, a display device and a display support, all removable as a unit from the slicer body.

3. The food slicer of claim 1 wherein the weigh platter is mounted on a platter support arm that runs to a load cell, wherein the weigh platter is removable from the platter support arm without tools by vertical movement upward.

4. The food slicer of claim 3 wherein the weigh platter includes a mount block at its underside and the mount block includes one or more lower openings that slide onto one or more upstanding projections of the support arm.

5. The food slicer of claim 1 wherein a plurality of removable slicer support feet interconnect a base of the portion scale to an underside of the slicer body.

6. The food slicer of claim 5 wherein each slicer support foot includes a portion extending upward through an opening in a respective mount flange of the base.

7. The food slicer of claim 1 wherein the portion scale includes a base mounted below the slicer body, the base is formed as a tray that houses a load cell of the portion scale, wherein the weigh platter is mounted on a platter support arm that runs from the load cell upward alongside of the slicer body.

8. The food slicer of claim 7 wherein the portion scale includes a display device, the display device mounted to an upright display support arm that has a lower end fixed within the base.

9. The food slicer of claim 8 wherein the display support arm defines an internal wiring passage for interconnecting control components for operating the portion scale with both (i) control components for operating slicing operations and (ii) a power source.

10. The food slicer of claim 1, further comprising:
a controller configured to track one or more of slicing strokes of the food product carriage, a run time of a knife drive motor, a run time of a carriage drive motor, slicer on/off iterations, slicer power usage, or one or more slice weight characteristics.

11. (canceled)

12. The food slicer of claim 1, further comprising:
a controller configured with a slice efficiency mode in which the controller (i) prompts an operator via a display device to weigh a bulk food item prior to slicing, (ii) captures and stores a first weight of the bulk food item as indicated by the portion scale, (iii) captures and stores a sliced weight upon completion of slicing, (iv) prompts the operator via the display to reweigh the bulk food item, (v) captures and stores a second weight of the bulk food item and (vi) calculates a slice efficiency for the slicing operation based upon the first weight, the second weight and the sliced weight.

13. The food slicer of claim 12 wherein the controller is configured to display the slice efficiency on the display device and/or log the slice efficiency in memory and/or send slice efficiency data to a remote device via a communications link.

14. The food slicer of claim 1, further comprising:
a controller configured with a slice efficiency mode in which the controller tracks a running weight of slices of a bulk food item, calculates an average weight per slice and compares the average weight per slice to a target weight per slice.

15. The food slicer of claim 14 wherein the controller is configured such that if the average weight per slice is offset from the target weight per slice by more than a predefined amount, the controller prompts the operator via a display device to take corrective action in the nature of at least one of (i) a message to decrease slice thickness, (ii) a message to increase slice thickness or (iii) a message to sharpen the slicer knife.

16. The food slicer of claim 1, further comprising:
a knife drive motor linked to rotate the slicer knife;
a carriage drive motor linked for automatic reciprocation of the food product carriage;
a controller configured with a cut to target weight mode in which the controller will carry out an automatic slicing operation of a bulk food item while monitoring an actual sliced weight indicated by the portion scale until a target sliced weight is achieved, at which point the controller stops the automatic slicing operation.

17. The food slicer of claim 1, further comprising:
a knife drive motor linked to rotate the slicer knife;
a display device;
a carriage drive motor linked for automatic reciprocation of the food product carriage;
a system of sensors including:
a first temperature sensor position to monitor knife drive motor temperature;
a second temperature sensor positioned to monitor carriage drive motor temperature;
a third temperature sensor positioned to monitor temperature of a control board heat sink;
at least one vibration/shock sensor;
at least one sensor for detecting carriage drive motor load;
at least one sensor for detecting knife drive motor load;
a controller configured to monitor the system of sensors to identify one or more fault conditions in the nature of actual fault conditions or potential fault conditions, and upon identification a fault condition the controller (i) logs the fault condition in memory and (ii) displays an alert message on the display device and/or sends an alert message via a communications link to another device.

18. The food slicer of claim 1, further comprising:
a knife drive motor linked to rotate the slicer knife;
a slicer knife sensor system positioned proximate a peripheral edge of the slice knife for determining a distance between at least one sensor and the slice knife;
a controller configured to monitor output from the slicer knife sensor system and to identify a wobble condition of the slicer knife based upon variations in the determined distance during slicer knife rotation.

19. The food slicer of claim 18 wherein the slicer knife sensor system includes a first laser distance sensor at a first side of the slicer knife and a second laser distance sensor at a second side of the slicer knife.

20-26. (canceled)

27. A food slicer for slicing food items, comprising:
a slicer body;
a slicer knife mounted for rotation relative to the slicer body, the slicer knife having a peripheral cutting edge, and an associated knife drive motor;
a slicer knife sensor system positioned proximate a peripheral edge of the slice knife for determining a distance between at least one sensor and the slice knife;
a controller configured to monitor output from the slicer knife sensor system and to identify a wobble condition of the slicer knife based upon variations in the determined distance during slicer knife rotation.

28. A food slicer for slicing food items, comprising:
a slicer body;
a slicer knife mounted for rotation relative to the slicer body, the slicer knife having a peripheral cutting edge, and an associated knife drive motor;
a display device;
a carriage drive motor linked for automatic reciprocation of the food product carriage;
a system of sensors including:
at least one temperature sensor;
at least one vibration/shock sensor;
at least one motor load sensor; and
a controller configured to monitor the system of sensors to identify one or more fault conditions in the nature of actual fault conditions or potential fault conditions, and upon identification a fault condition the controller (i) logs the fault condition in memory and (ii) displays an alert message on the display device and/or sends an alert message via a communications link to another device.
